(19) United States
(12) Patent Application Publication
(10) Pub. No.: US 2006/0229983 A1
(43) Pub. Date: Oct. 12, 2006

(54) METHOD AND APPARATUS FOR PROCESSING ANNUITIES

(76) Inventor: Steven Lundberg, Edina, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/276,916

(22) Filed: Mar. 17, 2006

Related U.S. Application Data
(60) Provisional application No. 60/662,881, filed on Mar. 17, 2005.

(51) Int. Cl. G06Q 40/00

(52) U.S. Cl. 705/40; 705/35

(57) ABSTRACT

This document describes, among other things, systems and methods for processing patent annuities or maintenance fees. In an embodiment, a method maintains records of patents or applications and their associated annuity or maintenance fees. The method generates a display or report that includes when a payment is due, the amount of each payment, and an indication of each patent's value or importance, wherein the value or importance is determined by an automatic analysis of electronic data that pertains to the patent.

### RELATED APPLICATION

This application claims the benefit of priority, under 35 U.S.C. 119(e), to U.S. Provisional Application Ser. No. 60/662,881, filed on Mar. 17, 2005, which is incorporated herein by reference.

### BACKGROUND

A problem faced by many companies is determining which patents to maintain in force and which to let go abandoned by non-payment of annuity or maintenance fees.

### BRIEF DESCRIPTION OF THE DRAWINGS

FIGS. 1-3 are flowcharts illustrating generally methods according to example embodiments of the inventive subject matter.

FIG. 4 is an example of a user-interface in accordance with the inventive subject matter.

FIG. 5 is a schematic view of machine capable of performing methods according to example embodiments of the inventive subject matter.

### DETAILED DESCRIPTION

According to a first embodiment of the inventive subject matter herein, a server is provided. The server is set up as follows:
patents or applications for which annuities or maintenance fees may be due at some point in the future are recorded on the server (or any system of computers);
also recorded for each are one or more dates on which the annuities are due or by which a payment should be made, and how much the payment will be;
the server generates a list or file or display or report that shows upcoming annuity payments, showing the patent or application for which the payment is due, and the amount that will be due;
the server further provides, for each patent or application for which an annuity is due, an indication of the patent's potential value or importance, wherein the value or importance is determined by an automatic analysis of electronic data that pertains to the patent, such as:
   the length of one or more claims in the patent, with a claim with a relative few number of lines or words being of potentially greater value than one with a relative more number of lines or words, where in one example embodiment there are provided one or more thresholds of number of lines or words that indicate a relative potential value of the patent or application;
   the number of times that a particular patent has been cited as prior art in subsequently issued patents, wherein a patent that has been cited a relative many times is potentially worth more than one that has been cited a relative fewer number of times, where in one example embodiment there are provided one or more thresholds of number citations that indicate a relative potential value of the patent or application;
   the number of important words (as opposed to unimportant words like “of”, “the”, etc . . . ) in the patent document that match words in marketing or sales literature available in electronic form, such as on-line on a web site or stored electronically in other computing systems, wherein a greater number of matches indicates potential continued use of the patent as opposed to no continued use, or any other automatically electronically derived indication of whether the patent is still being used by the company;
   other automatic analytical measures that can be derived from one or more electronic databases, or any combination of such measures that may form a value or importance indication;
   wherein the one or measures of value or importance are presented in adjacent to or in association with each item enumerated in the list or file or display or report that shows upcoming annuity payments, to allow a person viewing the item to see an indication of the value or importance of the patent or application for which the decision must me made.
According to one example embodiment,
   users could log onto a web-based system, or other networked system, and view a patent annuity item for which a payment is due, and see the value or importance indication(s), and, based on this indication, decide to look into a patent further for desirability to pay or simply make a decision to pay or not pay;
   filter payments to be made by the value or importance of a patent for which a payment is due, so that patents that have high value or importance ratings can be automatically paid, or patents that have low value or importance ratings can be automatically identified for closer inspection.

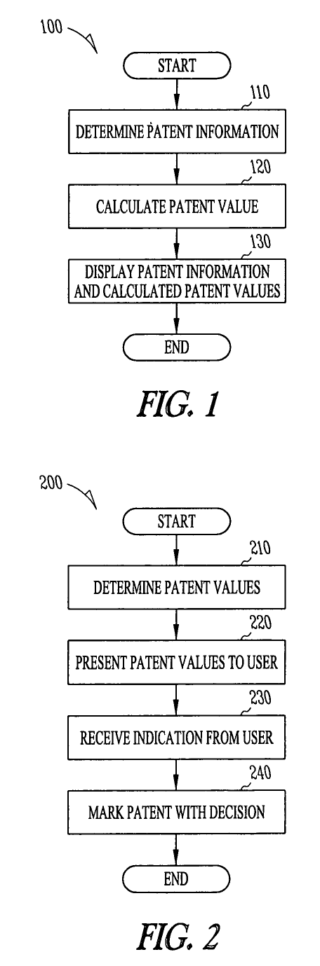

FIG. 1 is a flowchart illustrating generally a method 100 for calculating one or more patent values and providing the values to a user. At 110, patent information is collected and identified. Patent information may include intrinsic information, such as the number of claims or the size of the claims (measured in words or lines), or extrinsic information, such as the number of times the patent has been cited in subsequent patents. Other possible metrics include the number of important words (as opposed to unimportant words like “of” or “the”) in the patent document that match words in marketing or sales literature or other analytical measures that can be derived from one or more electronic databases, or any combination of such measures that may form a value or importance indication.

The method 100 uses the metric information to calculate the value of the patent 120 based on one or more threshold values. For example, one or more thresholds of the number of lines or words in a claim can be used to indicate a relative potential value of the patent or application, where a claim with a relatively few number of lines or words is considered to have potentially greater value than one with relatively more number of lines or words. Similarly, a threshold based on the number of times that a particular patent has been cited as prior art in subsequently issued patents can be established, where a patent that has been cited a relatively large number of times is considered to have potentially greater value than one that has been cited relatively fewer. In the example of word matches to sales or marketing literature, a threshold or weighting based on a greater number of matches that indicates potential continued use of the patent as opposed to few or no matches that may indicate discontinued use. Other electronically derived indications of whether the patent is still being used by the company can be used in such a calculation.

Information identifying the patent, such as a file number, patent title, or serial number, along with the calculated patent values is displayed 130 to a user. In one embodiment, the patent value is a numerical value in a range, such as one to ten, indicating an objective value of the patent. In other embodiments, the patent value may be represented as a textual description, such as “high,” “medium,” or “low,” or an alphanumerical description, such as “top 10,” “1 st tier,” or other indication of the relative value of the patent.

FIG. 2 is a flowchart illustrating generally a method 200 for receiving and recording payment decisions related to patent annuities or maintenance fees. In an embodiment, patent values are calculated 210, for example using the method 100 as described above. The patent values can be stored, for example in a database, for continued use. The method 200 displays 220 patent values and the associated patents to a user. The user can then take one or more actions based on the information displayed. For example, the user can indicate to pay or not pay the fee. In another example, the user can navigate a user-interface to explore more information related to the patent to assist the decision of whether to pay a fee. In one embodiment, the method 200 receives an indication 230 from the user of whether to pay or not to pay the fee due. The method 200 updates the display 240, for example marking the record with an indication showing that the patent fees are to be paid. The method 200 can then update a record in a database, for example, to reflect the decision. In some embodiments, a person or a process uses the recorded information to make a timely payment. In other embodiments, a system and method are used to process an immediate payment based on the user's decision.

FIG. 3 is a flowchart illustrating generally a method 300 for determining which patent fees to pay. In an embodiment, patent values are calculated 310, for example using the method 100 as described above. One or more threshold values are determined 320 and stored. In some embodiments, the threshold values are configurable by a user to reflect the relative value of certain metrics to the user. The method 300 scans a list of patents that have fees that are currently due and for each patent 330 the one or more threshold values are evaluated 340. In one embodiment, a single threshold value is used, such as the number of times the patent has been cited in subsequent applications. If the number of citations exceeds a threshold value, then the method 300 would mark the patent to pay 350. Alternatively, if the number of citations was less than the threshold value, then the patent can be marked for review 360. A user can then review the marked patents and make a decision based on other factors.

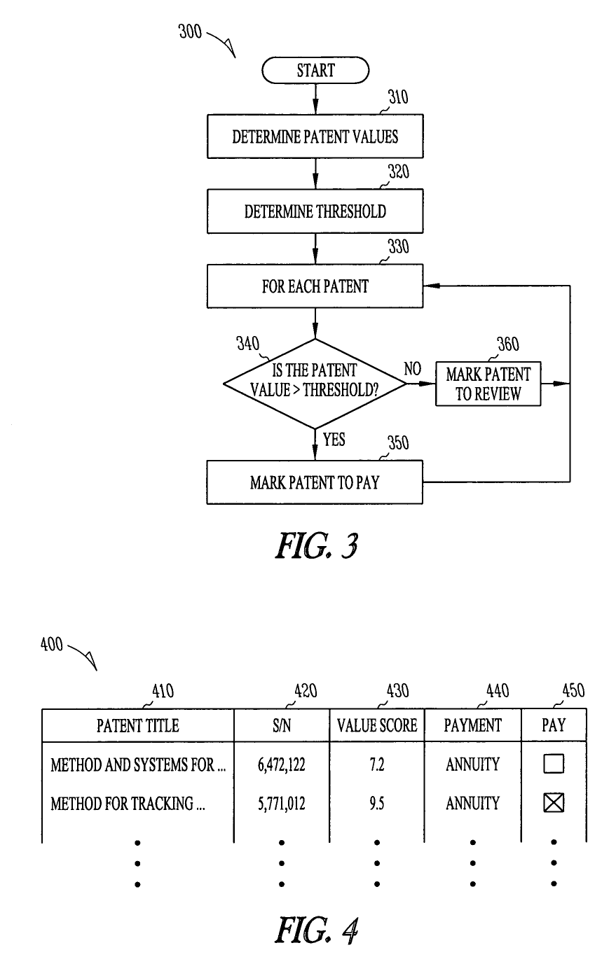

FIG. 4 is an example of a user-interface 400. A user is presented with identifying information, such as the patent's title 410 and serial number 420. A patent value score 430 is displayed associated with each patent. The payment type 440 is also displayed. A control 450 to indicate whether the scheduled payment will be made is provided. In an embodiment, the user can manipulate the control, such as by checking or un-checking, to manually control the decision of whether to pay or not. In an embodiment, a user can view more details of a patent by some action within the user-interface, such as double-clicking the patent title 410.

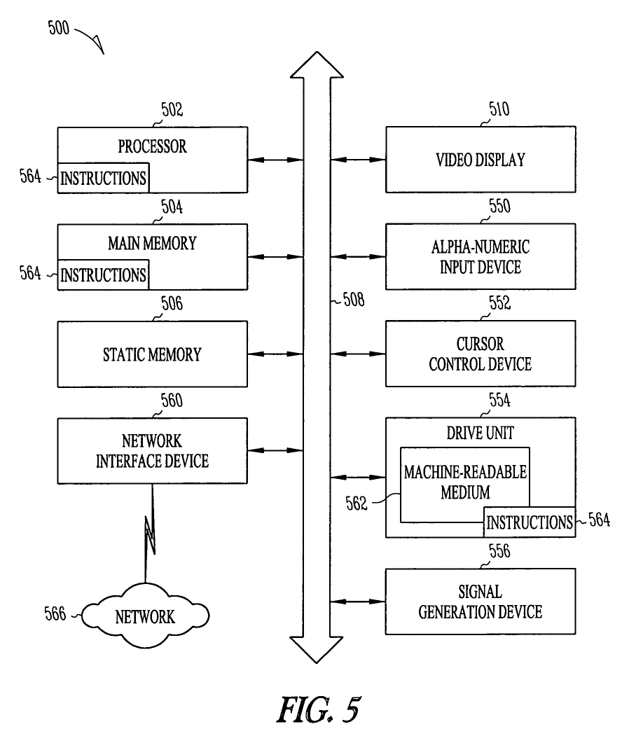

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504, and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 550 (e.g., a keyboard), a cursor control device 552 (e.g., a mouse), a disk drive unit 554, a signal generation device 556 (e.g., a speaker), and a network interface device 560. The disk drive unit 554 includes a machine-readable medium 562 on which is stored one or more sets of instructions, and data structures (e.g., software) 564 embodying or utilized by any one or more of the methodologies or functions described herein. The instructions 564 may also reside, completely or at least partially, within the main memory 504 and/or within the processor 502 during execution thereof by the computer system 500, the main memory 504 and the processor 502 also constituting machine-readable media. The instructions 564 may further be transmitted or received over a network 566 via the network interface device 560 utilizing any one of a number of well-known transfer protocols, for example the hyper text transfer protocol (HTTP).

While the machine-readable medium 562 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals.

In this description, numerous specific details are set forth. However, it is understood that embodiments of the invention may be practiced without these specific details. In other instances, well-known circuits, software, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the inventive subject matter can include any variety of combinations and/or integrations of the embodiments described herein. Each claim, as may be amended, constitutes an embodiment of the inventive subject matter, incorporated by reference into the detailed description. Moreover, in this description, the phrase “exemplary embodiment” means that the embodiment being referred to serves as an example or illustration. Further, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with reference to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel.

1. A method comprising:
maintaining a record of patents or applications for which annuities or maintenance fees may be due at some point in the future on a server or any system of computers;
recording for each are one or more dates on which the annuities are due or by which a payment should be made, and how much the payment will be;
generating a list or file or display or report that shows upcoming annuity payments, showing the patent or application for which the payment is due, and the amount that will be due;
generating, for each patent or application for which an annuity is due, an indication of the patent's potential value or importance, wherein the value or importance is determined by an automatic analysis of electronic data that pertains to the patent

2. A method according to claim 1 wherein the automatic analysis is selected from the group of:
the length of one or more claims in the patent, with a claim with a relative few number of lines or words being of potentially greater value than one with a relative more number of lines or words, where in one example embodiment there are provided one or more thresholds of number of lines or words that indicate a relative potential value of the patent or application;
the number of times that a particular patent has been cited as prior art in subsequently issued patents, wherein a patent that has been cited a relative many times is potentially worth more than one that has been cited a relative fewer number of times, where in one example embodiment there are provided one or more thresholds of number citations that indicate a relative potential value of the patent or application;
the number of important words (as opposed to unimportant words like “of”, “the”, etc . . . ) in the patent document that match words in marketing or sales literature available in electronic form, such as on-line on a web site or stored electronically in other computing systems, wherein a greater number of matches indicates potential continued use of the patent as opposed to no continued use, or any other automatically electronically derived indication of whether the patent is still being used by the company;
other automatic analytical measures that can be derived from one or more electronic databases, or any combination of such measures that may form a value or importance indication; or
the one or measures of value or importance are presented in adjacent to or in association with each item enumerated in the list or file or display or report that shows upcoming annuity payments, to allow a person viewing the item to see an indication of the value or importance of the patent or application for which the decision must me made.
